(19) United States
(12) Patent Application Publication
(10) Pub. No.: US 2019/0017785 A1
(43) Pub. Date: Jan. 17, 2019

(54) Multispectral Camouflage Material

(71) Applicant: Ametrine Technologies Ltd., Ein Hahoresh (IL)

(72) Inventors: Elad Morag, Ein Hahoresh (IL); Uria Kaplan, Ein Hahoresh (IL)

(21) Appl. No.: 16/025,642

(22) Filed: Jul. 2, 2018

Related U.S. Application Data
(63) Continuation-in-part of application No. 14/350,084, filed on Apr. 7, 2014.

(30) Foreign Application Priority Data
Oct. 11, 2011 (IL) 215717
Dec. 31, 2017 (IL) 256666

(51) Int. Cl. F41H 3/02; C03C 11/00; C03C 17/06; D03D 1/00; D03D 15/00

(52) U.S. Cl. CPC F41H 3/02; C03C 11/002; B32B 5/024; D03D 1/0047; D03D 15/00; C03C 17/06

(57) ABSTRACT

A fabric includes a first flexible fabric layer, having fabric emissivity properties in a visible radiation range that are selected so as to mimic ambient emissivity properties of a deployment environment of the fabric, and at least one second flexible fabric layer, which is joined to the first flexible fabric layer, and which is configured to scatter long-wave radiation that is incident on the fabric. The first and second flexible fabric layers are perforated by a non-uniform pattern of perforations extending over at least a part of the fabric.

### CROSS-REFERENCE TO RELATED APPLICATIONS

This application is a continuation-in-part application of U.S. patent application Ser. No. 14/350,084, filed on Apr. 7, 2014, which claims priority to PCT Application No. PCT/IB12/52142, filed on Apr. 29, 2012, which claims priority to Israeli Patent Application No. 215,707, filed on Oct. 11, 2011, the contents of which are incorporated by reference herein in their entirety. This application also claims priority to Israeli Patent of Addition Application Number 256,666, filed on Dec. 31, 2017, which claims priority to Israeli Patent Application No. 215,707, filed on Oct. 11, 2011, the contents of which are incorporated by reference herein in their entirety.

### FIELD OF THE INVENTION

The present invention relates generally to camouflage fabrics and implementations thereof, and particularly to layered fabrics having multi-spectral camouflage capabilities.

### BACKGROUND

The use of camouflage is a known technique for decreasing visibility of a person or object, e.g., in a daytime setting. At the same time, dark or nighttime settings have their own advantage in combat, such as providing stealth capabilities. Accordingly, significant efforts have been devoted to developing technologies that enable or improve visibility in the dark. For example, thermal imaging is a recognized technology for improving visibility in the dark. Thermal imaging systems generally assume that the variation in temperature between observed objects (e.g., both personnel and equipment) and their background will generate a correlated variation in emitted electromagnetic waves, provided that such electromagnetic waves are observed at an appropriate spectral range. Accordingly, such thermal imaging systems have impacted the stealth advantages of dark or nighttime settings.

Known camouflage technologies have not resolved the need for dynamic camouflaging, e.g., in daytime and nighttime conditions. Traditionally, camouflage fabrics have been colored and textured so as to make it difficult to visually distinguish the fabric from its surroundings (visual camouflaging, e.g., for daytime conditions). With the increasing importance of thermal and radar imaging in the battlefield, some camouflage fabrics are now designed to suppress infrared and/or microwave radiation, as well.

For example, U.S. Patent Application Publication 2010/0112316 describes a visual camouflage system that includes a vinyl layer having a camouflage pattern on its front surface with a site-specific camouflage pattern. A laminate layer is secured over the front surface of the vinyl layer, coating the camouflage pattern to provide protection to the camouflage pattern and strengthen the vinyl layer. One or more nanomaterials are disposed on the vinyl layer, the camouflage pattern, or the laminate to provide thermal and/or radar suppression.

As another example, U.S. Pat. 7,148,161 describes a thermal camouflage tarpaulin for hiding heat sources against detection in a thermal image. The tarpaulin comprises a base textile composed of a knitted or woven glass fabric on the side that is remote from the heat source with a compound whose reflectance values are in the region of a visual camouflage and/or in the infrared region. The base textile is provided with a free-standing polyester film to which a vapor-deposited coating that reflects thermal radiation has been applied on the side facing the heat source.

As a further example, U.S. Pat. No. 7,244,684 describes a thermal camouflage sheet for covering heat sources against identification in a thermal image. The sheet has a base textile with a glass filament, with a coating that contains aluminum powder on one side and a coating that contains color pigments on the other side. The remission values of the color pigments are in a range that allows camouflaging in the visual-optical and near infrared.

Prior art solutions for camouflage fabrics have not resolved the need for an approach to perform the above functions with accuracy, efficiency, or that has cross-applicability to many various implementations. Therefore, there is a need for systems and methods that address one or more of the deficiencies described above.

### SUMMARY

In light of the foregoing background, the following presents a simplified summary of the present disclosure in order to provide a basic understanding of some aspects of the invention. This summary is not an extensive overview of the invention. It is not intended to identify key or critical elements of the invention or to delineate the scope of the invention. The following summary merely presents some concepts of the invention in a simplified form as a prelude to the more detailed description provided below.

Embodiments of the present invention that are described hereinbelow provide multispectral, multipurpose camouflage materials that can be used in a wide range of different ambient conditions.

There is therefore provided, in accordance with an embodiment of the present invention, a fabric, including a first flexible fabric layer, having fabric emissivity properties in a visible radiation range that are selected so as to mimic ambient emissivity properties of a deployment environment of the fabric. At least one second flexible fabric layer is joined to the first flexible fabric layer, and is configured to scatter long-wave radiation that is incident on the fabric. The first and second flexible fabric layers are perforated by a non-uniform pattern of perforations extending over at least a part of the fabric.

Typically, the long-wave radiation scattered by the at least one second flexible fabric layer includes infrared thermal radiation and/or microwave radiation.

The perforations may have multiple different sizes and shapes, such as triangular or quadrilateral forms.

In disclosed embodiments, the at least one second flexible fabric layer includes microballoons, a metallic coating, and/or a conductive net.

There is also provided, in accordance with an embodiment of the present invention, a camouflage garment, including a fabric in accordance with any of the preceding claims, wherein the fabric is cut and sewn so as to be worn over the body of an ambulatory human subject.

The fabric may be cut and sewn so as to provide a first configuration that camouflages the subject in a daytime environment and, when the garment is turned inside-out, a second configuration that camouflages the subject in a nighttime environment.

There is additionally provided, in accordance with an embodiment of the present invention, a method for producing a fabric, which includes providing a first flexible fabric layer, having fabric emissivity properties in a visible radiation range that are selected so as to mimic ambient emissivity properties of a deployment environment of the fabric. At least one second flexible fabric layer, which is configured to scatter long-wave radiation that is incident on the fabric, is joined to the first flexible fabric layer. The first and second flexible fabric layers are perforated with a non-uniform pattern of perforations extending over at least a part of the fabric.

The present invention will be more fully understood from the following detailed description of the embodiments thereof, taken together with the drawings.

### BRIEF DESCRIPTION OF THE DRAWINGS

The present invention is illustrated by way of example and is not limited in the accompanying figures in which like reference numerals indicate similar elements and in which:

FIGS. 1A and 1B are schematic, sectional views of multispectral camouflage fabrics, in accordance with certain aspects of the present disclosure.

FIG. 2 is a schematic, sectional view of another multispectral camouflage fabric, in accordance with certain aspects of the present disclosure.

FIGS. 3 and 4 are schematic frontal views of perforated camouflage fabrics, in accordance with certain aspects of the present disclosure.

FIGS. 5A and 5B are schematic close-up front and rear views, respectively, of multispectral camouflage fabrics, in accordance with certain aspects of the present disclosure.

FIG. 6 is a schematic, sectional view of another multispectral camouflage fabric, in accordance with certain aspects of the present disclosure.

FIG. 7 is a process flow chart for constructing multispectral camouflage fabrics, in accordance with certain aspects of the present disclosure.

FIGS. 8A and 8B are schematic frontal views of multispectral camouflage suits, in accordance with certain aspects of the present disclosure.

FIGS. 9A and 9B are schematic front and rear views, respectively of multispectral camouflage pants, in accordance with certain aspects of the present disclosure.

FIGS. 10A and 10B are schematic front and rear views, respectively of a multispectral camouflage combat shirt, in accordance with certain aspects of the present disclosure.

FIGS. 11A and 11B are schematic front and rear views, respectively of a multispectral camouflage field shirt, in accordance with certain aspects of the present disclosure.

FIGS. 12A and 12B are schematic front and rear views, respectively of a multispectral camouflage vest, in accordance with certain aspects of the present disclosure.

FIGS. 13A and 13B are schematic isometric views of a multispectral camouflage vehicle cover system in a retracted position and an inflated position, respectively, in accordance with certain aspects of the present disclosure.

FIGS. 13C and 13D are schematic isometric and top views, respectively, illustrating a frame of the multispectral camouflage vehicle cover system of FIGS. 13A and 13B in an inflated position.

FIG. 14A-C illustrate exemplary thermal images of various types of garments, including garments employing multispectral camouflage fabric in accordance with certain aspects of the present disclosure.

### DETAILED DESCRIPTION OF EMBODIMENTS

Camouflage fabrics are used in producing military uniforms that reduce the daytime visibility of the wearer, but wearable camouflage against detection by long-wave sensors (thermal infrared or microwave radar) has yet to be widely deployed. Thermal and radar camouflage materials that are known in the art tend to be too heavy for use by ambulatory foot soldiers and do not allow sufficient ventilation or heat exchange to maintain a reasonable level of comfort. They are thus not practical for operational use. Moreover keys aspects of thermal imaging systems, as described hereinbelow, present additional challenges for effective thermal camouflaging.

I. Thermal Imaging Considerations

Electromagnetic radiation emitted by objects may be measured by spectral or radiant emittance, per unit surface area, which varies in accordance with the object's temperature and emissivity. Thermal imaging systems may be configured to measure such emittance in order to provide a form of night vision. In particular, assuming that the temperature and emissivity of a target object differs from that of its background, the object will be visible when observed at a particular spectral range based on the contrast between the emittance of the target object and its background. For example, thermal imaging systems may be designed to operate in spectral bandwidths that coincide with “atmospheric windows” in the range of 3-5 micrometers or 8-12 micrometers.

In order to quantify the performance of such thermal imaging systems, an observed target and its background may each be assumed to be an ideal black body, which is an idealized physical body that absorbs all incident electromagnetic radiation, regardless of frequency or angle of incidence. A black body may also be defined as a Lambertian light source (i.e., emitting only diffused light) at a temperature T, with unit emissivity (i.e., ϵ=1). Thus, the spectral radiant emittance for a black body in the wavelength range of [λ, λ+dλ] is expressed by Plank's law of radiation and is given by

$${W}_{λ} ( λ , T ) \cdot d λ = \frac{{c}_{1}}{{λ}^{5} ( {e}^{{c}_{2} / λ T} - 1 )} .$$

dλ, which may be provided in units of

$$\frac{W}{{cm}^{2} \cdot µm} ,$$

and where c1 and c2 are constants given by

$${c}_{1} = 3.7415 \cdot {10}^{4} [ \frac{W \cdot {µm}^{4}}{{cm}^{2}} ]$$

and c₂=1.4388·10⁴ [μm·K]. In general, the spectral/radiant emittance of objects with emissivity ϵ≠1 is given by Φ_{λ}(λ, T)·dλ=W_{λ}·ϵ·dλ, which may be provided in units of

$$\frac{W}{{cm}^{2} \cdot µm} . {Φ}_{λ} ( λ , T ) \cdot d λ$$

is the spectral radiant emittance in the spectral range [λ, λ+dλ] from a Lambertian source at a temperature T, and emissivity ϵ. While black bodies may be defined with emissivity ϵ=1, “gray” bodies may be defined with emissivity 0<ϵ<1, and for colored bodies with spectral emissivity may be defined with emissivity 0<ϵ(λ)<1.

Certain thermal imaging systems may measure the distribution of the spectral emittance in a setting, integrated over the spectral range to which the system is sensitive. The performance of such systems may be quantified by a figure of merit referred to as the “Noise Equivalent Temperature Difference” (NETD). More particularly, NETD is a measure for how well a thermal imaging system is able to distinguish between small differences in thermal radiation in an image, and is sometimes referred to as “thermal contrast.” When the noise is equivalent to the smallest measurable temperature difference, the system has reached its limit of its ability to resolve a useful thermal signal. In other words, the NETD expresses a minimal (or an averaged minimal) temperature difference between a target object and a background under the assumption that the target object and the background are ideal black bodies, and the signal to noise ratio required for detection is 1. As such, the NETD provides a performance measure for thermal imaging systems in terms of the net minimal temperature contrast between the target and the background.

The methodology for extracting the NETD for a given system, both theoretical and experimental, focuses on the parameters of that system (e.g., the spectral response and noise of each single detector in the detector array, f-number and transmissivity of the camera lens, and the integration time per detector in the detector array), and is detached from the emissivity and the deviation from net Lambertian behavior of both the target and its background. In other words, the NETD ignores issues related to differences in emissivity between the target and the background, or differences in the specular reflection from the target and the background. Thus, the NETD provides a general quantitative tool for comparing thermal imaging systems, independent of the settings in which such systems operate.

As the NETD is widely used, there is a need for thermal camouflage fabric that minimizes the probability of detection as quantified by the NETD. However, there is a large variability of the background emissivity between different geographical arenas, and under different weather conditions. Moreover, by nature of the fact that a target may often effectively be a heat engine that differs in temperature from its environment, use of thermal camouflage fabric between the target and its environment may affect the heat exchange, and hence the heat balance, between the target and its environment. This, in turn, affects the thermal spectral signature of the thermal camouflage fabric itself. In addition, as described, the NETD ignores the effect of differences in the specular reflection between the target and its background and affects the probability of detection of the target.

II. The Fabric Structure

Embodiments of the present invention that are described hereinbelow address these problems, for example, by providing a multispectral camouflage fabric that may be sufficiently light and ventilated to be used in suits or other garment pieces for ambulatory human subjects. The fabric may also be suitable, however, for covering animals, vehicles, boats, aircraft and stationary objects. The fabric may comprise one fabric layer having emissivity properties in the visible radiation range that are selected so as to mimic ambient emissivity properties of the deployment environment of the fabric, thus providing visual camouflage. One or more additional flexible fabric layers may be configured to scatter long-wave radiation that is incident on the fabric and thus provide infrared and/or microwave camouflage. These one or more additional fabric layers may be joined to the visual fabric layer.

The fabric layers may be perforated by a non-uniform pattern of perforations extending over part or all of the fabric. These perforations may have multiple different sizes and shapes, such as different triangular or quadrilateral forms. Such non-uniform perforations may provide ventilation to the inside of the fabric, reduce the fabric weight, and/or blur long-wave radiation returned by the fabric to thermal and radar imaging devices. These features may be valuable across many various camouflage applications, and may be particularly useful when the fabric is cut and sewn to be worn over the human body as a camouflage garment, such as a full-body camouflage suit.

In accordance with certain aspects of the present disclosure, thermal camouflage fabrics may be designed to minimize the spectral emittance contrast between a target and background in various environments, and therefore to cause the target to effectively blend with the background, rather than block the radiation emitted by the target. Exemplary thermal camouflage fabrics, when covering a target, may reduce the difference in radiant emittance of infrared (IR) radiation measured by a thermal imaging system between the target and the background due to differences in respective temperatures. These thermal camouflage fabrics may also alter the emissivity of the target to be more similar to the emissivity of the background, in both the visible and IR spectral ranges. Providing ventilation in the thermal camouflage fabrics may control the heat exchange between the target and the environment. Specular reflection properties of the thermal camouflage fabric may be adapted to minimize or reduce the difference in the specular reflection between the target and the background. Further modifications to the thermal camouflage technology may be provided to address human engineering factors, such as fabric weight, mobility, and/or flexibility, e.g., in operating various tools, weapons, and electronic equipment. Flexibility of the thermal camouflage fabric may be provided during portions of the fabrication process to enable fine-tuning of the relative performance of the different components of the fabric. Moreover, the fabrication process may be configured for a fast product turn out, and/or for the production of custom products adapted for different terrain and weather scenarios. Such thermal camouflage technology may include a number of elements as described herein to accomplish these functional and operational features.

In accordance with certain aspects of the present disclosure, thermal camouflage fabrics may provide the above described features implemented in a multi-component, single layer fabric. The various components of the thermal camouflage fabric may each contribute various properties as described above for improved thermal and visual camouflaging. The process of constructing such fabrics may include a multi-stage process flow. The composition and detail of each of the components, and the control of the parameters of each stage in the fabrication process, may result in the production of a fabric with enhanced or optimal performance for different terrain and weather scenarios.

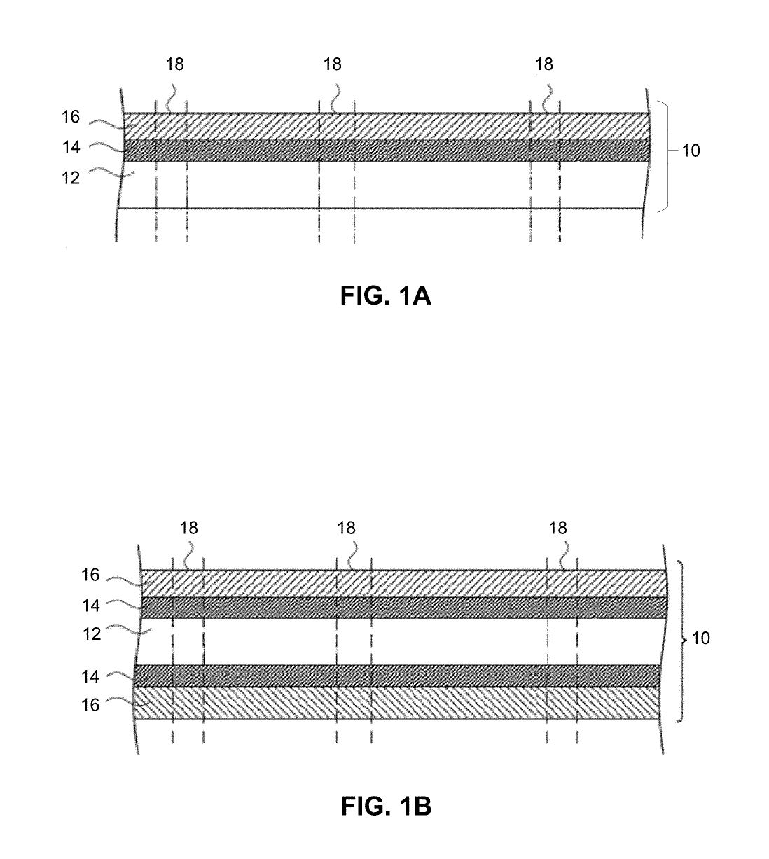

FIGS. 1A and 1B are schematic, sectional views of a fabric 10 that may be used in producing a garment or covering, as well as other camouflage items, in accordance with various aspects of the present disclosure. These figures illustrate particular sets of fabrics by way of example and not limitation. Some alternative structures are described below. The disclosed embodiments are capable of providing effective, multispectral camouflage under a range of conditions, including both night and day and climatic extremes, such as desert heat and arctic cold. The fabric may be passive and may operate without electrical power input.

Now referring to FIG. 1A, illustrating a schematic, sectional view of a thermal camouflage fabric 10 that includes a base fabric 12 (e.g., cotton, nylon, and the like) coated with a thin metallic coating 14, e.g., a silver coating. The fabric 10 further includes a printed layer 16 comprising a distribution of patterns (not shown), e.g., including different shapes of different colors and hues each painted with a predefined thickness. Printed layer 16 may include various patterns printed using low-emissivity pigments, and/or to match ambient colors and conditions for one or more particular settings. Ventilation perforations 18 may be provided at various portions over the surface area of fabric 10, and may extend partially or completely through the thickness of the fabric 10.

While FIG. 1A shows metallic coating 14 and printed layer 16 being printed on a same side of base fabric 12, in other examples metallic coating 14 and printed layer 16 may be printed on both sides of base fabric 12, as shown in FIG. 1B. Still in other examples, metallic coating 14 may be provided on both sides and printed layer 16 may be provided on a single side, or metallic coating 14 may be provided on a single side and printed layer 16 may be provided on both sides. Further, in some examples, metallic coating 14 and/or printed layer 16 may permeate through various portions of base fabric 12. Various other permutations of layering of the metallic coating 14, the printed layer 16, and the base fabric 12 may be provided without departing from the scope of the present disclosure. Moreover, while FIGS. 1A and 1B depict the various components as distinct layers, the components may in some examples be partially or fully permeated into other layers. For example, metallic coating 14 and/or printed layer 16 may permeate into and coat individual fibers comprising the base fabric 12. Metallic coating 14 may be applied to coat individual threads of the weave forming base layer 12 in certain examples of the present disclosure.

The fabric 10 may then be cut into pieces of predefined shapes and sewed together to form a thermal camouflage suit designed for covering specific objects (e.g., personnel and/or equipment). Moreover, the layering and configuration of fabric 10 may be designed based on a particular use and/or environment for the fabric. For example, fabric 10 may be provided with a printed layer 16 on one side with a suitable pattern for use in a first type of environment, e.g., daytime, and a printed layer 16 on the other side with a suitable pattern for use in a second type of environment, e.g., nighttime. Additionally, while FIGS. 1A and 1B schematically illustrate components of fabric 10 in various layer, fabric 10 may be implemented as a multi-component, single layer fabric.

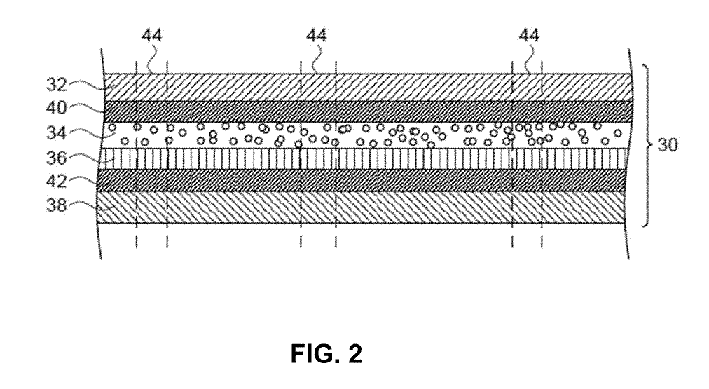

Now referring to FIG. 2, illustrating a schematic, sectional view of another thermal camouflage fabric 30 that includes an outer fabric layer 32, e.g., of ripstop cotton, nylon, and the like. Fabric layer 32 may include a suitable pattern (such as those described hereinbelow) printed thereon using low-emissivity pigments. Optionally, the pigments may be applied in the field, to match ambient colors and conditions.

An underlying layer 34 containing glass microballoons may be laminated to layer 32 using a spun web 40 of polyurethane fibers. The microballoons, whose sizes are in the range of 50-500 μm, scatter radiation, particularly infrared radiation, and thereby are capable of blurring thermal signature of the wearer. Alternatively or additionally, some or all of the microballoons may be coated with metal to improve their microwave-scattering properties and thereby blur the radar signature of the wearer. Although microballoons are typically round, some or all of the microballoons in layer 34 may be prismatic in shape. In alternative embodiments, microballoons may be located between other layers of the fabric or may be coated over the outer fabric surface.

A reflective layer 36 may be fixed to the underside of layer 34, to provide specular scattering of infrared and/or microwave radiation. Layer 36 may comprise, for example, a polyester weave coated with a metallic coating, such as titanium and/or aluminum or aluminum mixed with titanium oxide, gold, nickel and their alloys and/or oxides. The weave may alternatively be made using fibers containing suitable metals, in which case an additional layer of reflective lamination is not needed. The polyester may conveniently be a ripstop, water-repellant material.

For nighttime camouflage, an alternative outer layer 38 may be printed with a suitable pattern (also in low-emissivity pigment) and laminated to layer 36 by another polyurethane spun web 42. Layer 38, may comprise, for example, a 40-denier ripstop nylon, which is water-repellant and air-permeable, produced and coated using a suitable nano-process, which gives superior results to conventional water-repellant treatments using larger particles.

Multiple perforations 44 are cut through the layers of fabric 30. Typically, the perforations are in the range of 2-3 mm wide and are spaced 7-25 mm apart. The perforations may be of different shapes and sizes, as described hereinbelow. The sizes and spacing of the perforations may be selected so as to give sufficient ventilation while maintaining durability and strength of the fabric.

The overall thickness of fabric 30, based on the above sequence of layers, may be approximately 0.20-0.40 mm and the weight may be roughly 150-250 grams/m². A suit made from this fabric, as will be described herein, for example, may weigh about 800-1250 grams.

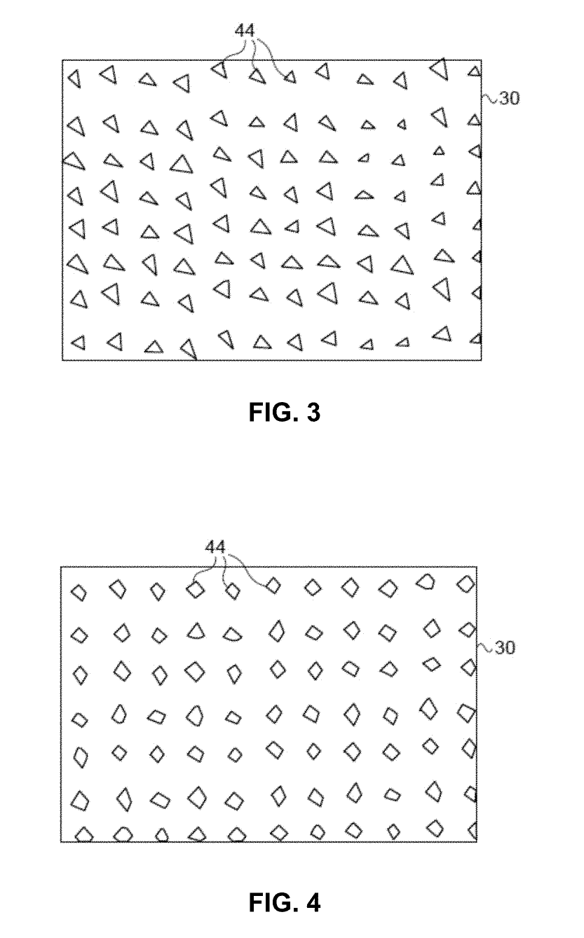

Now referring to FIGS. 3 and 4, which illustrate schematic frontal views of camouflage fabrics 30 having different sorts of perforations 44, in accordance with embodiments of the present disclosure. In the embodiment of FIG. 3, perforations 44 are triangular and are non-uniform in terms of both their sizes and orientations. In FIG. 4, the perforations may generally be quadrilateral and vary in size and overall shape. Although the perforations in FIGS. 3 and 4 are roughly evenly spaced, the spacing between the perforations may, additionally or alternatively, be non-uniform, as well.

As noted, perforations 44 may be useful in providing ventilation and to prevent overheating inside the fabric when being worn, and the non-uniformity of the perforations mat help to blur the thermal and/or radar signature of the wearer. For good ventilation in warm weather conditions, the perforations may be supplemented by vents in the sewn fabric. Typically, an air flow rate of 1-3 cubic feet per minute (CFM) at a pressure of 20-30 Pascal is desirable.

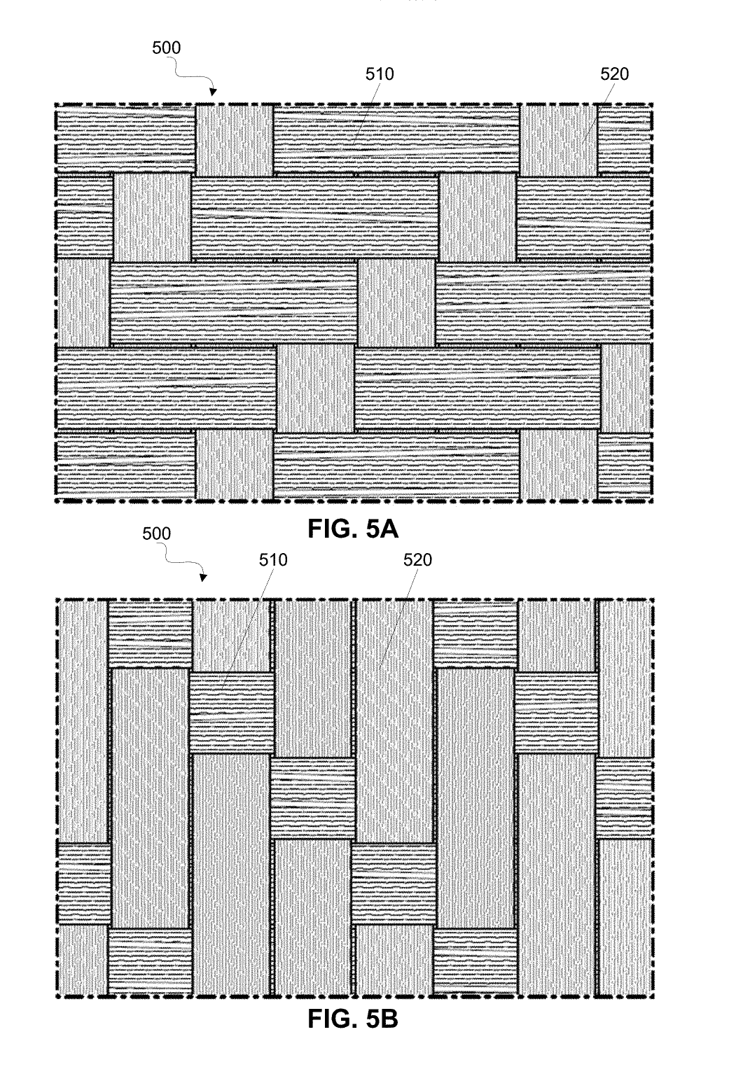

Now referring to FIGS. 5A and 5B, illustrating a schematic, close-up front and rear views, respectively of a thermal camouflage fabric 500. Fabric 500 may include woven threads of twill nylon, polyester, or the like. Fabric 500 may include coated threads 510, e.g., a metallic coating that provides specular reflection properties, woven with uncoated threads 520. The particular weaving of coated threads 510 with uncoated threads 520 may be varied to accomplished enhanced or optimized specular reflection properties for a particular environment. For example, as shown in FIGS. 5A and 5B, uncoated threads 520 are aligned in the vertical direction, and coated threads 510 are aligned in the horizontal direction. FIG. 5A illustrates a weave sequence of uncoated threads 520 passing under three yarns of coated threads 510 and then over one yarn of coated threads 510. Accordingly, the front view of FIG. 5A shows a surface area composed of more coated threads 510 than uncoated threads 520. However, rear view in FIG. 5B shows a surface area composed of more uncoated threads 520 than uncoated threads 510. While FIGS. 5A and 5B illustrate a weave ratio of 3:1, other weave ratios may be employed with camouflage fabrics, without departing from the scope of the present disclosure. For example, weave ratios of 1:1, 2:1, 4:1, 5:1, 3:2, 4:3, and so on, may be employed in various multispectral thermal camouflage fabrics.

Single strands of coated threads 510 and/or uncoated threads 520 may be combined to form yarns to be woven into the thermal camouflage fabrics described herein. FIGS. 5A and 5B illustrate yarns formed from approximately 20-30 strands of coated threads 510 and/or uncoated threads 520. However, various other ranges of thread count may be employed in the thermal camouflage fabrics without departing from the scope of the present disclosure. Further, while FIGS. 5A and 5B show yarns being formed of either uncoated threads 520 or coated threads 510, in some examples, yarns may be formed of both uncoated and coated threads.

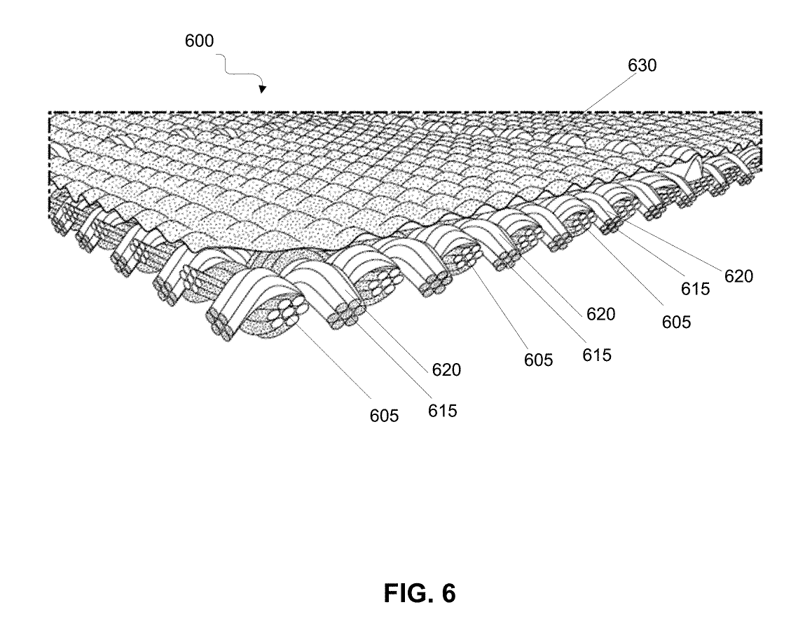

Now referring to FIG. 6, illustrating a schematic, perspective sectional view of a thermal camouflage fabric 600. Fabric 600 includes a layer of woven fibers 605, 615. As shown in FIG. 6, the woven fabric is formed by alternations of a first fiber 605 and a second fiber 615. First fiber 605 may be formed from bundling a series of threads, and covering the threads in metal coating 610 to form a relatively smooth fiber construction. Similarly, second fiber 615 may be formed by bundling a series of threads and covering the threads in a metal coating 620. Metal coating 620 may include, e.g., a silver film. Fabric 600 further includes a printed layer 630 comprising a distribution of patterns, e.g., including different shapes of different colors and hues each painted with a predefined thickness. Printed layer 630 may include various patterns printed using low-emissivity pigments, and/or to match ambient colors and conditions for one or more particular settings.

Ventilation perforations (not shown) may be provided at various portions over the surface area of fabric 600, and may extend partially or completely through the thickness of the fabric 600. More particularly, in certain examples, fabric 600, by its design, may provide built-in perforations via the dimensions of the thread bundling that make up fabric 600. Gaps between the thread bundling may thus act as small perforations through fabric 600. Fabric 600 being designed with such built-in ventilation may significantly reduce the number of regular perforations (e.g., perforations 44 as illustrated in FIGS. 3 and 4) added to fabric 600 after the weaving processes, and instead provide ventilation via the breathability of fabric 600. Further, while the various components described with respect to FIG. 6 are schematically illustrated as various layers, fabric 600 may be formed as a multi-component single layer construction in accordance with the various fabric construction processes described herein.

Processes for constructing such thermal camouflage fabric constructions may be provided in one or more stages of a fabrication process flow as described herein. Performance of heterogeneous solid/air structures such as textiles may be dependent on the micro and macro geometry of the structure as well the chemical characteristics of the material from which they are made. Geometric, mechanical and chemical characteristics of the fabric may be the result of the choice of polymers, fibers and/or the assembly of fibers into yarns and yarns into fabric in the creation of the fabric. In addition, fibers, yarns, and fabrics may undergo many chemical and physical finishing processes which create further variations in their technical performance.

The absorption of chemicals by the fabric may also be dependent on the structure or geometry of the fabric. Capillarity, porosity, surface tension, hydrophilicity, hairiness, fiber mass per unit area, and the like may influence additive uptake rate, saturation, uniformity, durability and distribution. Fabrics may be considered as hierarchical structures that include a range of polymers, fibers, yarns, fabrics, and/or finished products. These are detailed below with respect to performance criteria of various structures.

Regarding polymer/fiber materials, advantageous fiber forming polymer types include polyester, polyamide, man-made cellulosic, polylactic acid, vegetal cellulosics such as cotton and flax, acrylics such as polyacrylonitrile, protein fibers such as wool and silk, polyolefin fibers such as polypropylene and polyethylene, polyurethane fibers such as elastane, and mixtures thereof. A degree of polymerization of such polymers may preferably be above 500. These polymers may have a melting or decomposition temperature from about 80° C. to about 350° C. In some example, a preferred melting or decomposition temperate may be above 120° C.

In certain examples, useful fiber/polymer morphology may be defined by a degree of crystallinity greater than 70% and a degree of orientation greater than 50%. A glass transition temperature (Tg) may preferably be between about 40° C. and about than 130° C. Thermal shrinkage may preferably be below 20%. Fiber specific strength (tenacity) may be above 5 grams per denier (GPD). Elastic elongation may be between about 5% and about 25%. However, in some examples implementing elastomeric fibers such as elastane, elongation may be up to about 400%. Fiber count or fineness may be between about 0.5 decitex and below 50 decitex. A cross-sectional shape of a fiber may be round, oval, multi-lobal, kidney, segmented, hollow, multicomponent or grooved. A length of the fiber about 5 millimeters to continuous filament, and a fiber crimp range may be in a range from 0 to 10 crimps per centimeter. Fibers may contain no delusterant such as titanium dioxide (bright), some delusterant (semi-dull), or a large amount of delusterant (dull).

Regarding yarn-specific parameters, a yarn count (thickness) range may be about 10 to 10,000 decitex. A continuous multifilament yarn may have about 2 to 1000 filaments in the cross section, and may be flat, textured, air entangled or crimped. A twist level or direction range of the yarn may range from about 0.5 to 50 turns per inch (TPI), in an S or Z twist direction. Yarn plying range may be about 0.5 to 50 turns per meter (TPM), with 2 to 9 plies.

Regarding fabric-specific parameters, a fabric structure may be woven knit, warp knit, or nonwoven. Fabrics may be composed of yarns having a per unit length and width range of about 20 to 700 yarns per square inch (YPI). A type and uniformity of the interlacing of the fabric may be knit, composed of non-isotropic, convoluted yarn resulting in a thick, stiff, deformable, non-draping structure, or woven, resulting in a semi isotropic, straight, thin structure with good drape, or nonwoven having an isotropic, fibrous nature. A tightness of the fabric interlacing may affect a fabric cover factor, which may range from about 1 to 50%. Fabric thickness may range from about 0.1 to 10 millimeters. A fabric weight per unit area may range from about 15 to 1,200 grams per square meters (GSM). For pile fabrics, pile heights may range from about 0.1 to 5 millimeters. A fabric tear strength may preferably be above 1 kilogram using a falling pendulum (Elmendorf) apparatus.

Preferably, the construction of the fabric may be comprised of a woven fabric made of at least two types of continuous multifilament yarn woven together to form the fabric. In some examples, each type of multifilament yarn may be made from a different synthetic polymer, e.g., one being a polyester, such as polyethylene terephthalate and the other one being a polyamide, such as nylon 6.6.

The yarns comprising the fabric may be woven together in a 1×2, 1×3, 1×4 or 1×5 double faced twill weave with apertures or covered area of predefined sizes. The apertures may contribute significantly to the ventilation capability of the fabric. The size of the apertures may be determined by setting the picks per inch (PPI) and yarn density of the warp during the weaving and the heat setting step. Fabric loom thread count may range from 80×220 to 220×80. In some examples, polyester multifilament yarns may be interlaced between nylon multifilament yarns, forming an orthogonal superstructure which gives the fabric enhanced strength, endurance, and light weight. The ratio of polyester to nylon yarns may range from 1:1 to 1:10. Fabric weight may range from 100 to 140 GSM.

In some examples, the fabric may be constructed as a stretch woven fabric made of three types of continuous multifilament yarns that are woven together. Each type of multifilament yarns may be made from a different synthetic polymer. For example, one yarn may be polyester, such as polyethylene terephthalate, another yarn may be polyamide, such as nylon 6.6, and the other yarn may be spandex. The various yarns may be woven together in a double weave with apertures or covered areas of predefined sizes as described herein. The apertures may contribute significantly to the ventilation capability of the fabric. The size of the apertures may be determined by setting the picks per inch (PPI) and yarn density of the warp during the weaving and the heat setting step. Fabric loom thread count may range from 100×300 to 300×100. In some examples, polyester multifilament yarns may be interlaced sparsely between nylon multifilament yarns, forming an orthogonal superstructure to give the fabric enhanced strength, endurance and light weight. The ratio of nylon to polyester to spandex yarns may ranges from 1:1:1 to 8:2:0.5. Fabric weight may range from 120 to 150 GSM.

In certain examples, the fabric construction may include a ripstop woven fabric made of nylon 6.6 continuous multifilament yarns that are woven together. The yarns may be woven together in a ripstop weave with apertures or covered areas of predefined sizes in the above-described ranges. The apertures may contribute significantly to the ventilation capability of the fabric. The size of the apertures may be determined by setting the picks per inch (PPI) and yarn density of the warp during the weaving and the heat setting step. Fabric loom thread count may range from 100×100 to 200×200. The fabric weight may range from 30 to 40 GSM.

In other examples, the fabric construction may include a warp knit tricot fabric made of nylon 6.6 yarns that are knit together to form the fabric. The yarns may be knit on a two to four bar tricot warp knitting machine with apertures or covered areas of predefined sizes in the ranges discussed herein. The apertures may contribute significantly to the ventilation capability of the fabric. The size of the apertures may be determined by setting the yarn density in each bar and yarn density of the warp as well as the heat setting conditions. Warp density may range from 800 to 1,200 ends. Each bar may be threaded with 300 to 700 ends. The fabric weight may range from 80 to 120 GSM.

In some examples, the thermal camouflage construction may include a weft knit single jersey fabric made of three types of yarns that are woven together to form the fabric. Each type of multifilament yarn may be made from a different synthetic polymer. For example, one yarn may be modacrylic, one yarn may be viscose, and the other yarn may be an antistatic fiber. These yarns may be woven or knit together to form the fabric. In some examples, the yarns may be knit on a weft knitting machine with apertures or covered areas of predefined sizes as described herein. The apertures may contribute significantly to the ventilation capability of the fabric. The size of the apertures may be determined by setting knitting parameters for course and wale density as well as the heat setting conditions. The fabric weight may range from about 160 to 220.

A variety of other material combinations may be implemented into the thermal camouflage construction without departing from the scope of the present disclosure.

Table 1 below lists typical materials that can be used in these structures, while Tables A-J show examples of layer structures that can be composed from these materials.

TABLE 1
LAYER MATERIALS

| | | Thickness | |
|---|---|---|---|
| Label | Description | (typical) | |
| COTTON | Printed cotton (see layer 32 above). | 0.20 | mm |
| | For example, M3526 PA/CO fabric, | | |
| | produced by DIATEX (St- | | |
| MBG | Glass microballoons (see layer 34 above). | 0.06 | mm |
| | For example, 3M ™ Glass Bubbles, K | | |
| | Series or S Series, produced by 3M Energy | | |
| | and | | |
| METP | Metal Powder, such as powders 516H, | 10-20 | μm |
| | 510HV, 5900FHV, or 5906PAF produced by | | |
| | PAC (Loveland, Ohio); or aluminum | | |
| | metallic powder CI 77000, produced by | | |
| | Mallinckrodt Baker, Inc. | | |
| MBG - | Glass microballoons with metal | 0.06 | mm |
| COATED | coating, such as the 3M materials mentioned | | |
| SWPU | Spun web - polyurethane (see layers 40 and | 0.06 | mm |
| | 42 above). For example, VILENE, produced | | |
| | by Freudenberg Anlagen- und | | |
| | Werkzeugtechnik KG (Neuenburg, | | |
| | Germany). | | |
| COMPMET | Metal-coated polyester weave (see layer 36 | 0.05 | mm |
| | above). Such materials are available, for | | |
| | example, from Shing Fu Textile Technology | | |
| | Co. (Cingshuei | | |
| NANO | Nano-treated nylon (see layer 38 above), | 0.06 | mm |
| | such as kk-k00mceps40drsn fabric, produced | | |
| | by K&K Advance Textile Solutions | | |
| | (Holon, Israel). | | |
| MNET | Conductive metal net with electro- magnetic | 0.09 | mm |
| | shielding properties, such as PONGE, | | |
| | produced by Soliani EMC (Como, Italy). | | |
| UVCPA | UV-curing printable adhesive, such as 3M ™ | 2-5 | μm |
| | Screen Printable UV-Curing Adhesive 7555, | | |
| | produced by 3M (St. Paul, Minnesota). | | |
| DES-SA | Desert sand | | |
| NANO-MET | Nano-treated nylon with metal coating, such | 0.06 | mm |
| | as the K&K Advance Textile Solutions | | |
| | materials | | |

TABLE A
(This sort of fabric is useful particularly in reversible
camouflage suits for forest and desert environments.)

COTTON
SWPU
MBG
COMPMET
SWPU
NANO

TABLE B
(Useful particularly as a reversible covering for stationary
objects in forested and desert environments.)

MBG
METP
UVCPA
COTTON
SWPU
NANO

TABLE C
(Useful particularly as a reversible covering for armored vehicles,
when stationary or mobile, in forested and desert environments.)

DES-SA
UVCPA
NANO
SWPU
COMPMET
SWPU
COTTON

TABLE D
(Useful particularly for as a reversible camouflage
cover for infantry posts and as personal camouflage
netting in forested and desert environments.)

COTTON
MBG
METP
UVCPA
NANO

TABLE E
(Useful particularly for as a reversible camouflage
cover for infantry posts and as personal camouflage
netting in forested and desert environments.)

COTTON
MBG - COATED
UVCPA
NANO

TABLE F
(Useful particularly in reversible camouflage
suits for forest and desert environments.)

COTTON
SWPU
COMPNET
SWPU
NANO

TABLE G
(Useful particularly as a reversible covering for mobile
armored vehicles in forested and desert environments.)

COTTON
SWPU
COMPNET

TABLE H
(Useful particularly as camouflage in areas of extreme temperatures,
including both snowy and very hot environments.)

NANO-MET
SWPU
COTTON

TABLE I
(Useful for multi-spectral camouflage - including radar blocking -
particularly for boats, aircraft, and strategic land vehicles, such
as missile carriers and mobile command/control systems.)

COTTON
SWPU
MNET
SWPU
NANO

TABLE J
(Useful for camouflage of strategic objects.)

MBG
UVCPA
COTTON
SWPU
MNET
NANO

The above embodiments are shown here only by way of example, and alternative layer structures, which will be apparent to those skilled in the art upon reading this specification, are also considered to be within the scope of the present invention.

III. Fabric Construction Processes

In order to achieve the various thermal camouflaging properties described herein, a multispectral thermal camouflage fabric may be implemented in a single fabric construction in accordance with various processes described herein.

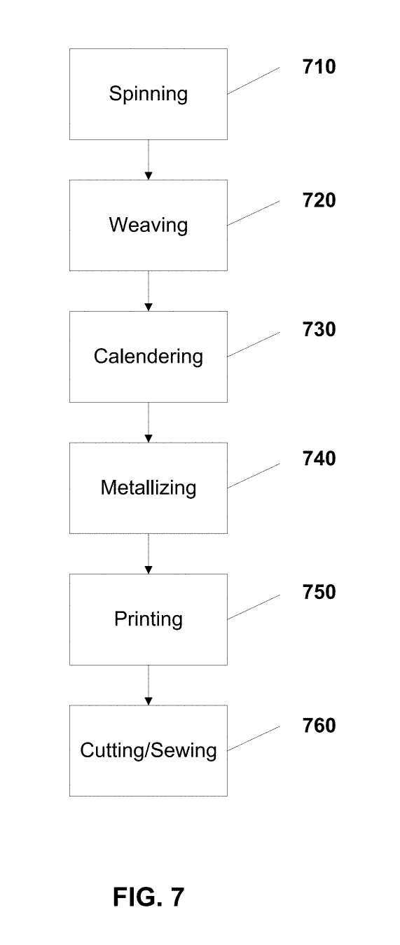

FIG. 7 illustrates a process flow chart for assembling a thermal camouflage fabric construction in accordance with various aspects of the present disclosure. First, the polymers or fibers may be spun into a yarn during spinning step 710. During the spinning step 710, the yarn may be varied, e.g., to create a thin yarn, a thick yarn, and/or to vary a number of filament in the yarn. The yarns are next woven to form a fabric during weaving step 720. During the weaving step 720, the fabric may be varied, e.g., by selecting a ratio of thin and thick yarns and/or be selecting a particular weaving density. Next, during calendering step 730, the fabric may be scoured, heat set, and calendered to provide a smooth surface for subsequent processing. The spinning and weaving processes may produce a fabric construction at is able to control heat exchange between a target and its environment via ventilation in the fabric construction.

The fabric construction is then coated with a thin metallic coating, e.g., a silver coating, during metallizing step 740. The metallizing step 740 may include an auto-catalytic, electro-less processes, such as those known in the industry. The metallizing step 740 may allow for control of a thickness and a granularity of the metallic coating, which each affect the ratio between specular reflection and the diffusing reflection properties of the fabric. After the metallizing step 740, the fabric construction weight may, in some examples range from 150 to 200 GSM, or in other examples, may range from 160 to 240 GSM. The metallizing process may produce a fabric construction that is able to reduce the difference in radiant emittance of IR radiation, as emitted to a thermal imaging system, between the target and the background due to difference in the respective temperatures of the target and the background.

Next, the fabric constructions goes through printing step 750, in which the metallized fabric construction is printed with a distribution of patterns of varying shapes, sizes, colors, and/or thicknesses. The printing step 750 may be performed using gravure, flexographic, screen, or digital methods. A pattern distribution may be selected based on matching or appearing similar to a specific terrain, or weather or time of day scenario. In certain examples, each side of the fabric construction may be printed with a different distribution of patterns such that the same piece of fabric construction may be used in multiple sets or terrain or weather scenarios. After the printing step 750, the fabric construction weight may, in some examples range from 180 to 260 GSM. Aspects of the printing step 750 may be customized so as to vary print layer thicknesses in conjunction with various fabric types, to vary reflection levels in conjunction with various fabric types and/or thermal background characteristics, and/or to provide visual camouflage to match a particular environmental background. The printing step 750 may be implemented via multiple layers of digitally printed patterns, printed one layer on top of another. Each layer of printing ink may contribute different patterns of color and/or different thicknesses. In some examples, there may be different pattern combinations associated with each fabric type. In some examples, various pattern distributions may be associated with a particular environmental background, e.g., woodland, desert, all weather, and the like. Accordingly, the printing process may produce a fabric construction that is able to adapt the emissivity of a target to be similar to the emissivity of the background. The weaving step 720, the calendering step 730, and/or the printing step 750 may produce a fabric construction that is able to adapt it specular reflection properties in order to minimize or reduce differences between the specular reflection of the target and the specular reflection of the background.

Finally, at cutting/sewing step 760, the fabric construction is cut and sewn into a shape suitable for a particular target object. The finished fabric may be cut and sewn to form a garment. The design of the garment may include ventilation openings, patches, loose panels (wavers), and/or wrinkles, as described herein. These, together with the colored pattern distribution via the printed layer, may give the garment the random emissivity to match the background emissivity in a particular environment.

IV. Implementations of the Fabrics

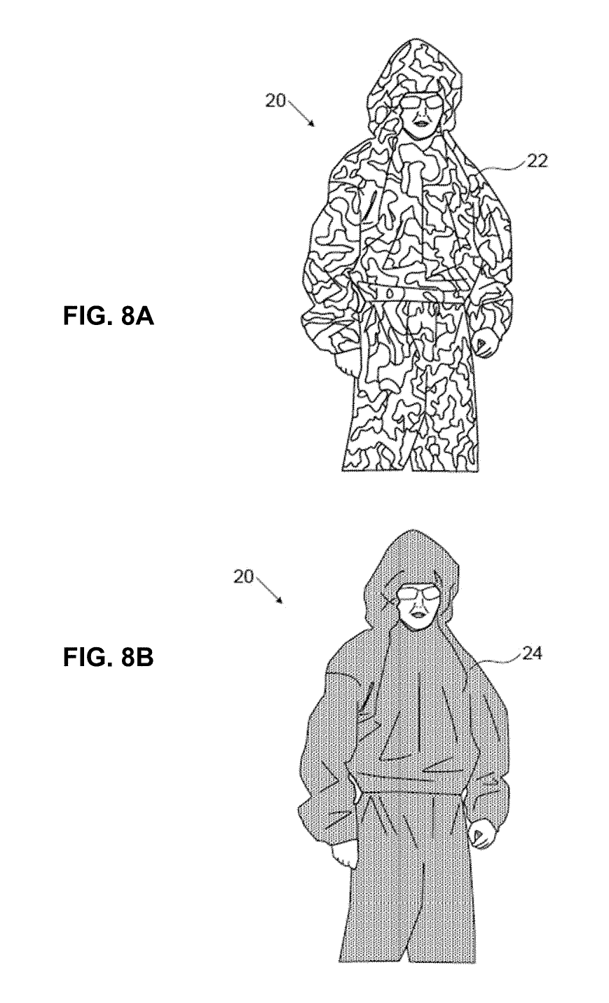

FIGS. 8A and 8B are schematic frontal views of a multispectral camouflage suit 20 worn by a human subject, in accordance with certain aspects of the present disclosure. The suit may be formed from fabric that includes a reversible multi-layer laminate, as described herein. The suit may include coverings for the subject's hands and face, as well (not shown in the figure). Although the figures show a particular sort of full-body camouflage suit, the fabrics described herein may similarly be used in producing camouflage garments of other sorts.

In certain examples, the fabric construction may be cut and sewn into suits or uniforms designed to be worn by a human being. For example, FIG. 8A shows the daytime configuration of suit 20, in which a first outer fabric layer 22 has emissivity properties that mimic the daytime visual environment in which the suit is to be used. FIG. 8B shows the nighttime configuration, obtained by turning suit 20 inside-out. In this latter configuration, the inner layer in the configuration of FIG. 8A becomes a second outer fabric layer 24, which is chosen for its low emissivity and infrared-reflecting properties (spectral and/or diffuse). By reflecting infrared radiation from the environment, layer 24 appears to be at approximately the same temperature as its environment and therefore resists detection by thermal imaging devices. The ability of suit 20 to provide both visual and thermal camouflage and to operate under both day and night conditions reduces the cost of outfitting each soldier (or other subject) and reduces the volume and weight of equipment that the soldier must carry.

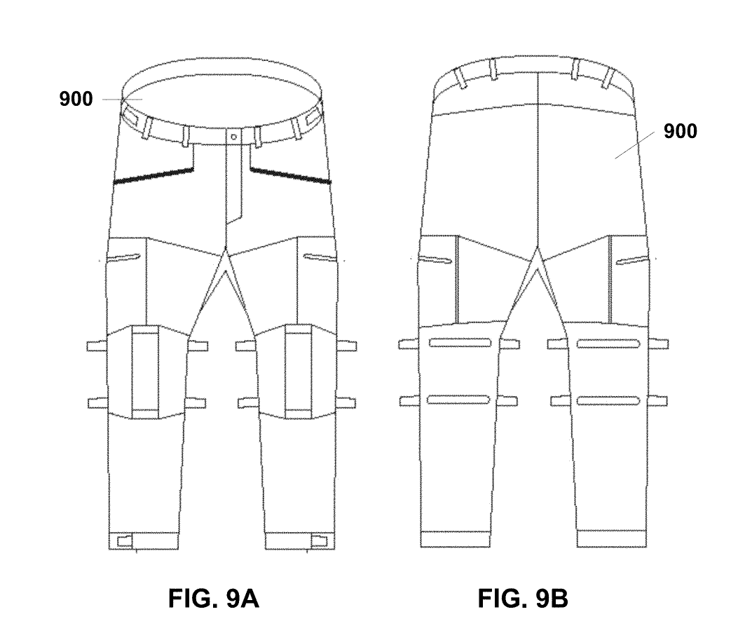

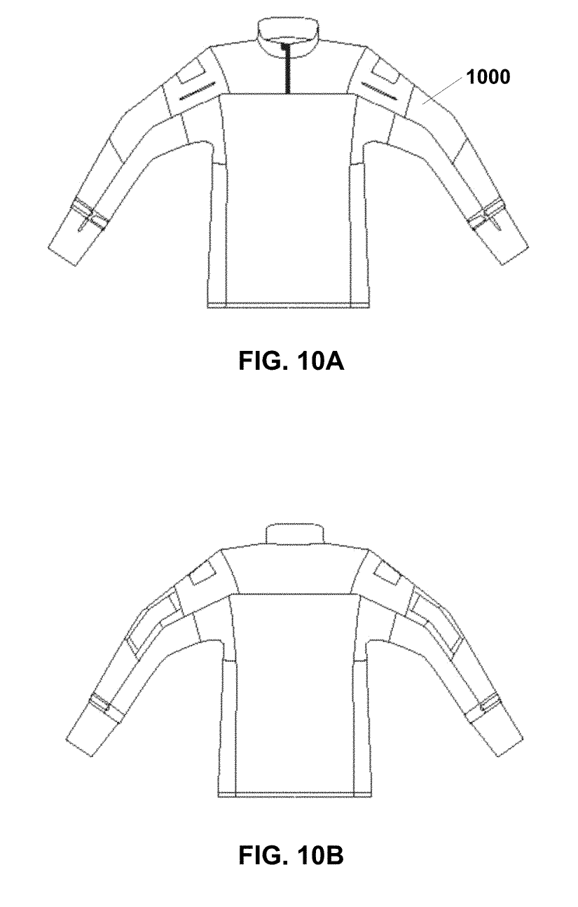

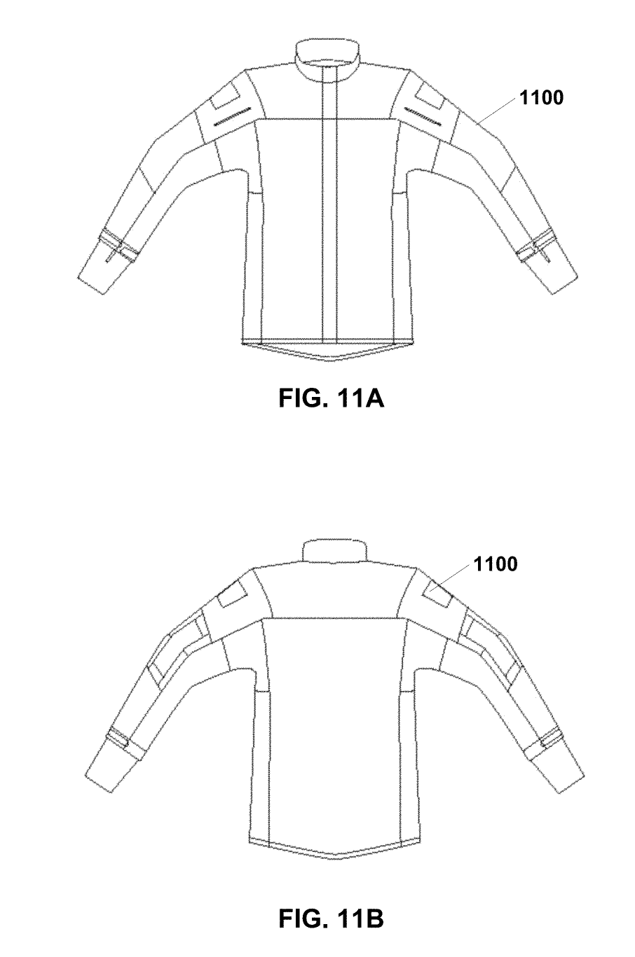

In certain examples, the fabric construction may be cut and sewn into various other garment pieces designed to be worn by a human being, including but not limited to combat pants, such as combat pants 900 of FIG. 9, combat shirts, such as combat shirt 1000 of FIG. 10, combat suits, diver dry suits, diver wet suits, flight suits, such as field shirt 1100 of FIG. 11, body armor (hard or soft), maritime combat uniforms, civilian clothes such as pants, shirts, or jackets, and the like. Such garment pieces may be designed with further features to enhance performance characteristics. For example, mittens may be removably connected to sleeves of combat short 1000 and/or field shirt 1100. For another example, a head covering may be provided which still provide full range of view for a wearer, e.g., with the usage of netted screens. Additionally, for such garment pieces, various combinations of opening with nets to increase ventilation and fabric types may be selected to optimize or enhance thermal camouflage performance metric.

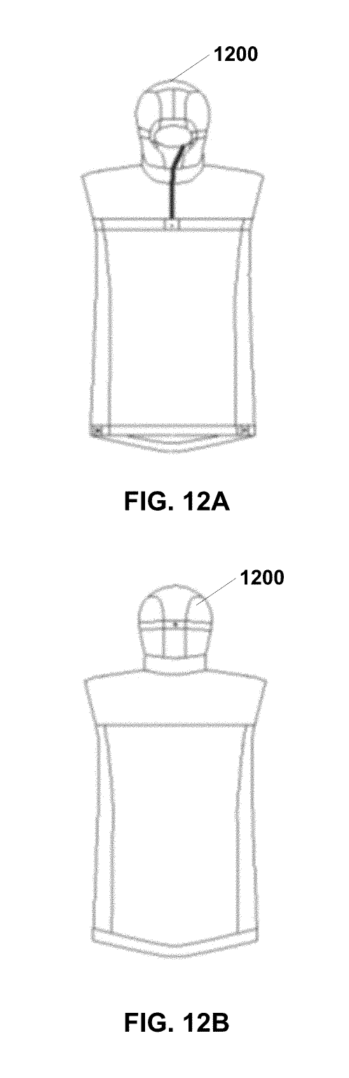

In certain examples, the fabric construction, may be cut and sewn into a multispectral signatory reduction vest cover 1200, as shown in FIG. 12. Vest cover 1200 may include a cord management system equipped in the hood, a ventilation opening in the hood, a cord management system in the waist, pockets and closable openings to access equipment stored in pockets on the front and back sides, dual sided camouflage, flaps, a built-in sniper cover or net, and/or a maritime vest cover with built in jet boot covers. Various accessories may be provided wish such thermal camouflage fabric, including but not limited to, one-sided or dual sided rolls for storing weapons and/or equipment, built-in mittens, built-in shoe covers, gloves, sleeping bags, blankets, survival blankets, backpacks, shoes, fins, helmet covers, weapons (e.g., barres and silencers), parachutes, and the like.

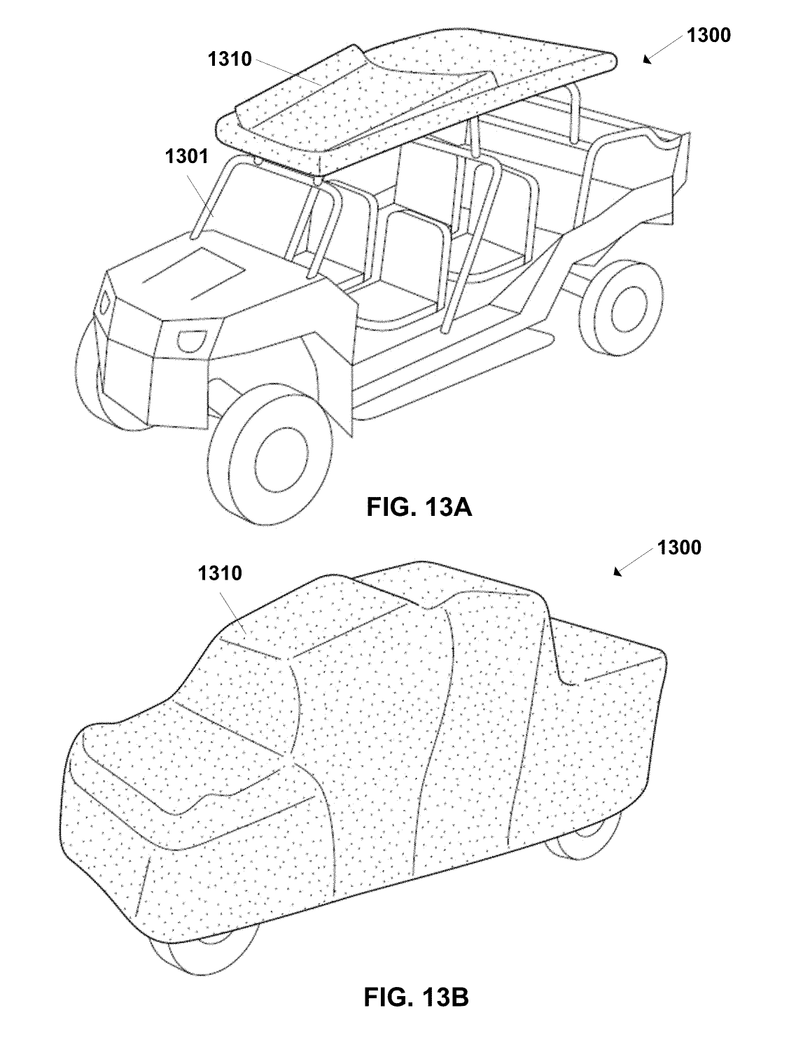

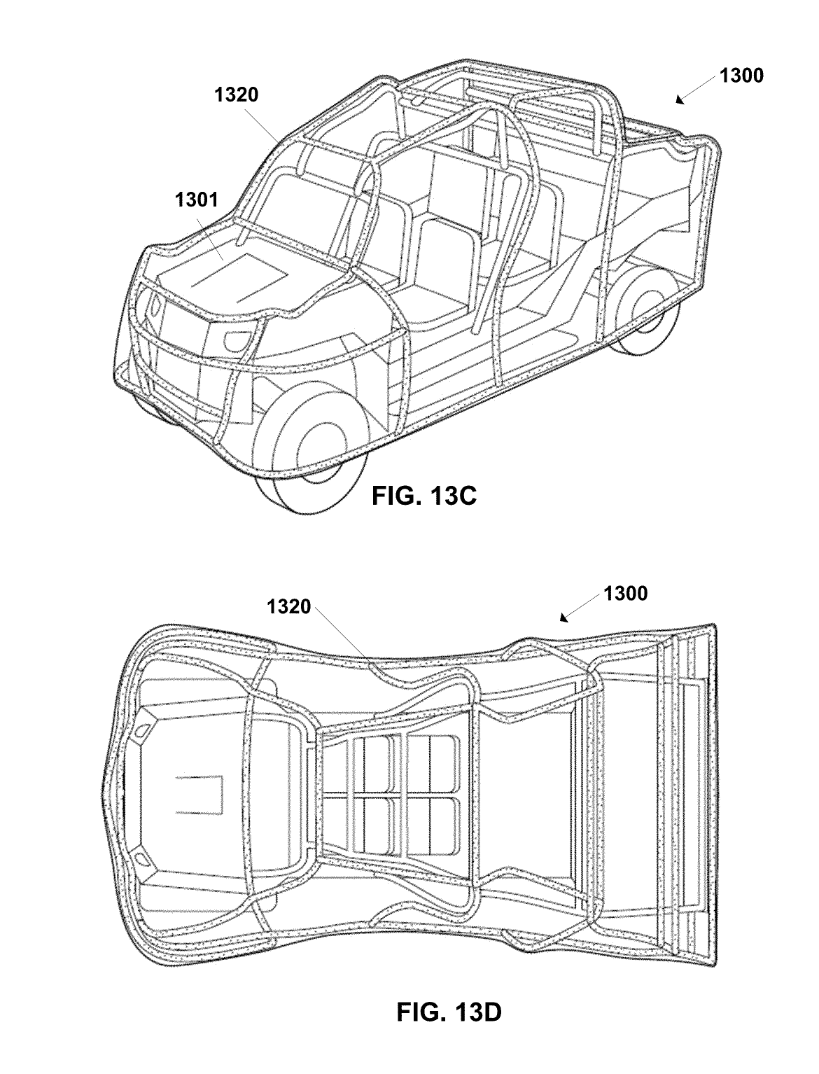

Still, in certain other examples, the fabric construction may be cut and sewn so as to cover non-living objects, e.g., vehicles, including but not limited to cars, trucks, other utility land vehicles, airplanes, boats, and the like. For example, FIGS. 13A and 13B depict a thermal camouflage system 1300 including an inflatable cover 1310 and frame 1320 for covering a vehicle 1301. Inflatable cover 1310 may be configured to transition from a deflated position (FIG. 13A) in which cover 1310 is retracted and not visible, to an inflated position in which cover 1310 is extended and covers at least a portion of vehicle 1301, e.g., side and top portions of vehicle 1301. System 1300 may be configured such that cover 1310 is able to transition between extended and retracted positions when the vehicle 1301 is stationary or when moving. For example, system 1300 may include a control system that includes suitable hardware for automatically transitioning a position of cover 1310 in response to a position change input, e.g., from a user-engageable input.

System 1300 may include a frame 1320 which supports cover 1310 thereon, when in the inflated position. For example, as shown in FIGS. 13C and 13D, cover 1310 wraps around frame 1320 when inflated such that cover 1310 rests on various portions of frame 1320 and covers vehicle 1301. Prior to transitioning to the inflated portion, a folded or retracted cover 1310 and frame 1320 may be attached to a roof portion of vehicle 1301. Deployment of cover 1310 and frame 1320 may occur during various operational states of the vehicle 1301, include when vehicle 1301 is in motion. Cover 1310 may be mounted and removed easily from vehicle 1301, e.g., and be repositioned on another vehicle. Cover 1310 may be composed of a light fabric constructions, such as the thermal camouflage constructions discussed herein, and/or may implement thermal and visual camouflage feature. Cover 1310 may be composed of a flexible, lightweight, and inflatable fabric material. In some examples, cover 1310 may be transparent, and certain portions the surface area of cover 1310 may be attached by magnet to an inflatable structure, such as frame 1320, so that users, e.g., the passengers in the vehicle 1301, may transition the cover 1310 between the inflated and retracted position, without impeding operation of the vehicle, and/or allowing such passengers to be camouflaged from view.

In certain examples, frame 1320 may include retractable wheel spacers (not shown) in order to space the cover 1310 from the wheels of vehicle 1301 and allow full operation of the wheels when cover 1310 is deployed. Ventilation may be provided in the cover 1310, e.g., including ventilation to the engine areas. As described, cover 1310 may be composed the camouflage fabrics described herein, and therefore provide a multispectral visual, thermal, IR, acoustic, and radar signature reductions for the vehicle 1301 when deployed.

In certain examples, the cover 1310 and inflatable frame 1320 may be stored on a roof portion of vehicle 1301, when a camouflage cover is not needed. Inflatable frame 1320 may include a rigid tubular cage structure that, when deployed, encases the vehicle 1301. Frame 1320 may be connected to chassis of vehicle 1301 via straps with quick disconnect connectors. As the frame 1320 is deployed, cover 1310 may be simultaneously, or shortly thereafter, deployed so as to cover the frame 1320 over the vehicle 1301. Inflating or deploying cover 1310 and frame 1320 may be performed in a number of ways, including but not limited to an air tank, an electric blower, and a hand pump.

System 1300 provides a number of benefit in addition to multispectral camouflaging. For instance, cover 1310 may provide a shelter against weather element such as rain, snow, wind, or the sun. Moreover, such sheltering benefits also allow for the cover 1310 to be deployed in a number of environments and weather conditions. Cover 1310 and frame 1320 may also include hydrophobic materials that prevent water absorption and thus providing a waterproof covering. Additionally, the impact of any accumulated precipitation on the weight or aerodynamics of system 1300 will therefore be minimized Cover 1310 may include netted windows to provide operators of vehicle 1301 with a field of view and/or flap door opening to allow operators to exit the vehicle 1301 while cover 1310 is deployed. Because system 1300 does not impede on the interior area of the vehicle 1301, users inside the vehicle may still conduct other tasks while in the vehicle 1301 when cover 1310 is deployed, such as operating guns or other weapons. System 1300 may be configured to be operable independent of vehicle 1301 and there be configured to be easily mounted and dismounted to various vehicles or other suitable structures. System 1300 mat be packed and stored in a rooftop of vehicle 1301, or in a side pack (not pictured) on a side of vehicle. Cover 1310 may be adjustable, flexible, and be designed, when deployed, to have sufficient clearance from the ground and to allow access to equipment in the rear or side portions of vehicle, e.g., to access a spare tire.

Other systems similar to system 1300 may be implanted for various other stationary or non-stationary objects. For example, an inflatable boat cover, e.g., having an inflatable bow part, a robot or drone covering, and an inflatable tent shelter, e.g., to hide one or more persons, may be provided, in accordance with certain aspects of this disclosure.

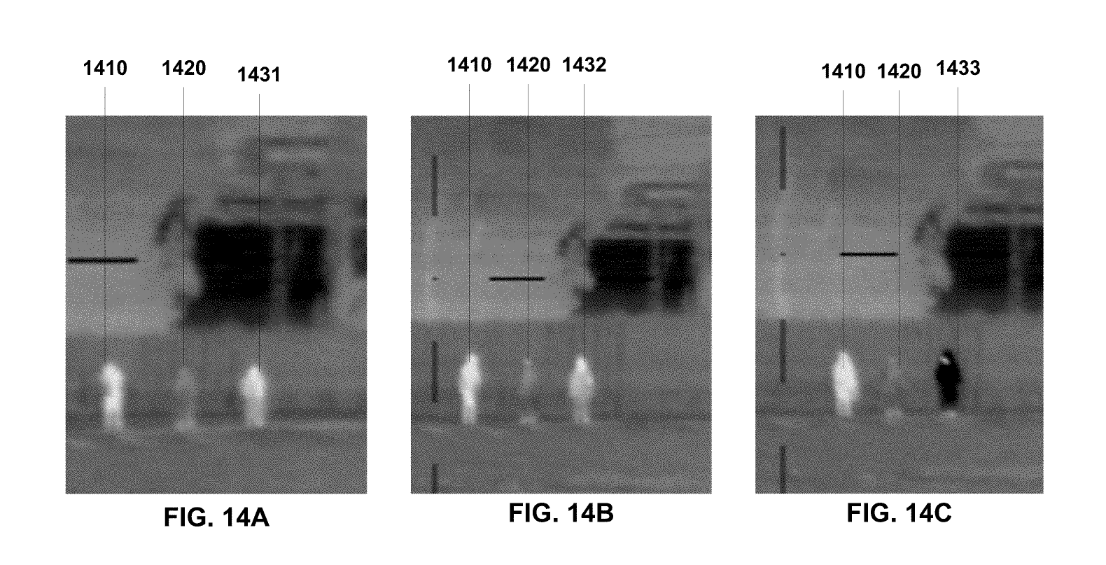

Now referring to FIG. 14A-C, example thermal images are provided, showing various types of garments, including garments employing multispectral camouflage fabric in accordance with certain aspects of the present disclosure. The various garment shown in FIG. 14A-C are suits which may be designed to be worn by human subjects. Reference suit 1410 shows a garment without camouflaging components. As shown in FIG. 14A-C, reference suit 1410 is shown as having a visibly lighter appearance than the surrounding environment. A first partial camouflage suit 1431 of FIG. 14A shows a suit including ventilation (e.g., including perforations through the fabric to prevent warm up of the external layer and to prevent heat buildup between the subject wearing the suit and the fabric) and an external layer of printed pigmentation (e.g., a visibly opaque and IR transparent layer providing conventional, visual camouflage), but not including a metallic layer (e.g., to at least partially block IR radiation produced by the subject wearing the suit). A second partial camouflage suit 1432 of FIG. 14B shows a suit including an external layer of printed pigmentation and a metallic layer, but not including ventilation. A third partial camouflage suit 1433 of FIG. 14C shows a suit including ventilation and a metallic layer, but not including an external layer of printed pigmentation. As shown in FIG. 14A-C, first, second, and third partial camouflage suits 1431, 1432, and 1433 are all detectable to some extent in thermal imaging systems.

A multispectral camouflage suit 1420, e.g., including the various component discussed herein, including but not limited to FIG. 1A-6, is shown is FIG. 14A-C. Multispectral camouflage suit 1420 includes an external layer of printed pigmentation, a metallic layer, and ventilation. As shown in FIG. 14A-C, multispectral camouflage suit 1420 is substantially less visible than reference suit 1410 and first, second, and third partial camouflage suits 1431, 1432, and 1433, and is nearly or completely undetectable in thermal imaging systems via the combination of the various components described herein. Additionally, an intermediate layer may be provided between the external layer and the metallic layer, which may provide IR emissivity and IR reflection (e.g., both specular and scattering) as well as insulation. Thus, the various components of multispectral camouflage suit 1420, in combination, may be configured to (1) at least partially block IR radiation produced by the subject wearing the suit; (2) adapt the emissivity at visible wavelengths of the external layer so as to generally mimic the emissivity of the background environment; (3) provide ventilation to prevent warm up of the external layer, limit or prevent the external layer from becoming an IR source, and improve normal operational conditions for the subject wearing the suit; (4) provide insulation between the metallic layer and the external layer so as to reduce or prevent warm up of the external layer and limit or prevent the external layer from becoming an IR source; and (5) provide emissivity and reflection at IR wavelengths similar to the background environment, which may include a balance between specular reflection and scattering. Accordingly, these combinations of component may produce a lightweight and flexible fabric that provides significantly enhanced multispectral thermal camouflage properties.

It will be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

Aspects of the invention have been described in terms of illustrative embodiments thereof. Numerous other embodiments, modifications, and variations within the scope and spirit of the appended claims will occur to persons of ordinary skill in the art from a review of this disclosure. For example, one of ordinary skill in the art will appreciate that the steps illustrated in the illustrative figures may be performed in other than the recited order, and that one or more steps illustrated may be optional in accordance with aspects of the invention.

While preferred embodiments and example configurations of the invention have been herein illustrated, shown and described, it is to be appreciated that various changes, rearrangements and modifications may be made therein, without departing from the scope of the invention as defined by the claims. It is intended that specific embodiments and configurations disclosed are illustrative of the preferred and best modes for practicing the invention, and should not be interpreted as limitations on the scope of the invention as defined by the appended claims and it is to be appreciated that various changes, rearrangements and modifications may be made therein, without departing from the scope of the invention.

While the invention has been described with respect to specific examples including presently preferred modes of carrying out the invention, those skilled in the art will appreciate that there are numerous variations, combinations, and permutations of the above described systems and methods. Those skilled in the art will understand that various specific features may be omitted and/or modified in without departing from the invention. Thus, the reader should understand that the spirit and scope of the invention should be construed broadly as set forth in the appended claims.

1. A camouflage fabric construction comprising:
a base layer including a woven structure of fibers;
a metallic coating over at least a portion of the woven structure of fibers, the metallic coating being designed to at least partially block a subject thermal infrared radiation by partial scattering and partial specular reflecting of the subject thermal infrared radiation;
a patterned pigmentation printed over the base layer and the metallic coating and designed to visually mimic properties of an environment; and
a plurality of perforations sized and dimensioned to provide partial ventilation to reduce heat generated by the subject, each of the plurality of perforations extending through the base layer, the metallic coating, and the patterned pigmentation.

2. The camouflage fabric construction according to claim 1, wherein the camouflage fabric construction is cut and sewn to be worn on a human subject.

3. The camouflage fabric construction according to claim 1, wherein the camouflage fabric construction is cut and sewn to cover a vehicle.

4. The camouflage fabric construction according to claim 1, wherein the patterned pigmentation is printed on opposing sides of the base layer and the metallic coating.

5. The camouflage fabric construction according to claim 4, wherein the camouflage fabric construction is cut and sewn so as to provide a first configuration, with an outer fabric surface facing outward designed to provide visual camouflage in a first environment and, when the camouflage fabric construction is turned inside-out, a second configuration designed to provide visual camouflage in a second environment.

6. The camouflage fabric construction according to claim 1, wherein the metallic coating is applied to coat alternating fibers of the woven structure of the base layer.

7. The camouflage fabric construction according to claim 1, wherein the camouflage fabric construction is configured to scatter microwave radiation.

8. A method for producing a camouflage fabric, comprising:
weaving a multi-fiber construction into a fabric base, the fabric base include a series of ventilation perforations designed to control heat exchange through the fabric base;
coating at least a portion of the fabric base in a metallic coating configured to at least partially block a subject thermal infrared radiation by partial scattering and partial specular reflecting of the subject thermal infrared radiation; and
printing a patterned ink distribution on at least one side of the fabric base and metallic coating, the patterned ink distribution being designed to visually mimic properties on an environment.

9. The method according to claim 8, further comprising:
cutting a plurality of perforations through the fabric base, the metallic coating, and the patterned ink distribution, each of the plurality of perforations being sized and dimensioned to provide partial ventilation to reduce heat generated by a subject.

10. The method according to claim 8, further comprising:
cutting and sewing the fabric so as to form a covering to be worn over a subject.

11. The method according to claim 10, wherein the subject includes one of: a boat, a land vehicle, and an aerial vehicle.

12. The method according to claim 10, wherein cutting and sewing the fabric comprises providing a first configuration of the garment, with the outer surface facing outward, that camouflages the subject in a first environment and, when the fabric is turned inside-out, a second configuration that camouflages the subject in a second environment.

13. The method according to claim 8, further comprising calendering the fabric base to provide a smooth surface for covering with the metallic coating.

14. The method according to claim 8, wherein weaving multi-fiber construction into a fabric base comprises weaving fibers of varying thicknesses.

15. A multispectral camouflage fabric comprising:
a fabric base;
a metallized coating provided over at least a portion of the fabric base and designed to partially block a thermal infrared radiation of a subject by partial scattering and partial specular reflecting of the thermal infrared radiation of the subject; and
a patterned pigmentation designed to visually mimic properties of an environment,
wherein the multispectral camouflage fabric has a plurality of perforations sized and dimensioned to provide at least partial ventilation to reduce heat generated by the subject, each of the plurality of perforations extending through the patterned pigmentation, the metallized coating, and the fabric base.

16. The multispectral camouflage fabric of claim 15, wherein the multispectral camouflage fabric is cut and sewn to be worn over an ambulatory human subject.

17. The multispectral camouflage fabric of claim 15, wherein the multispectral camouflage fabric is cut and sewn to cover a vehicle.

18. The multispectral camouflage fabric of claim 17, further comprising an inflatable frame structure designed to support the multispectral camouflage fabric when covering the vehicle.

19. The multispectral camouflage fabric of claim 17, wherein the multispectral camouflage fabric is configured to be folded and housed in a roof or side portion of the vehicle when not covering the vehicle.

20. The multispectral camouflage fabric of claim 17, further comprising netted window portions designed to provide a field of view to operators inside the vehicle when the multispectral camouflage fabric covers the vehicle.
